(19) United States
(12) Patent Application Publication
(10) Pub. No.: US 2013/0084918 A1
(43) Pub. Date: Apr. 4, 2013

(54) WIRELESS COMMUNICATION DEVICE WITH SIM-TO-SD ADAPTOR

(71) Applicant: Subramanya SHESHADRI, Bangalore (IN)

(72) Inventor: Subramanya SHESHADRI, Bangalore (IN)

(73) Assignee: Broadcom Corporation, Irvine, CA (US)

(21) Appl. No.: 13/252,032

(22) Filed: Oct. 3, 2011

(51) Int. Cl. H04W 88/02

(52) U.S. Cl. 455/558

(57) ABSTRACT

An adaptor card is disclosed that allows a wireless communication device to access and communicate with a SIM card trough an SDIO terminal accessibly located at an exterior of the device. The adaptor card includes a SIM receiving terminal configured to receive a SIM card. The SIM receiving terminal includes a SIM interface that contacts the plurality of pins located on the SIM card in order to communicate with an IC chip located on the SIM card. The adaptor card further includes a signal conversion module that converts signals between a SIM protocol for signals transmitted to, or received from, the SIM card, and an SD protocol for signals transmitted to, or received from, the electronics device. The signal conversion module is also configured to map the signals received at the terminals of the adaptor card to the corresponding terminals of the SIM card.

### BACKGROUND

1. Field of Invention

The invention relates to a wireless communication device, and more specifically to a wireless communication device that allows for easy access and removal of a SIM card.

2. Related Art

Wireless communication devices, such as cellular telephones to provide an example, are becoming commonplace in both personal and commercial settings. The wireless communication devices provide users with access to all kinds of information. For example, a user can access the internet through an internet browser on the device, download miniature applications (e.g., “apps”) from a digital marketplace, send and receive emails, or make telephone calls using a voice over internet protocol (VoIP). Consequently, wireless communication devices provide users with significant mobility, while allowing them to remain “connected” to communication channels and information.

Wireless communication devices communicate with one or more wireless access points to send and receive data. Typically, a first wireless communication device generates and transmits a radio frequency modulated with encoded information. This radio frequency is transmitted into a wireless environment and is received by the access point. The access point demodulates and decodes the received signal to obtain the information. The access point may then respond in a similar manner. The wireless communication devices can communicate with the access points using any well-known modulation scheme, including simple amplitude modulation (AM), simple frequency modulation (FM), quadrature amplitude modulation (QAM), phase shift keying (PSK), quadrature phase shift keying (QPSK), and/or orthogonal frequency-division multiplexing (OFDM), as well as any other communication scheme that is now, or will be, known.

The wireless communication device is typically granted permission to communicate with the access point via a service provider, such as a mobile telecoms operator/carrier. However, most service providers do not own the physical access points (e.g., cellular towers or base stations), but rather lease capacity from a network operator. Thus, in order to identify a mobile device attempting to communicate with a base station, Subscriber Identity Module (SIM) cards have been introduced for use in wireless communication devices.

A SIM is an integrated circuit that securely stores a service-subscriber key (IMSI) used to identify a subscriber on mobile telephony devices (e.g., mobile phones and computers). The SIM is held on a removable SIM card, which can be transferred between mobile devices. SIM cards have a number of standard sizes, and are defined by a plurality of standards. For example, ISO/IEC_{—}7810:2003, ID-1, ISO/IEC_{—}7810:2003, ID-000 and ETSI TS 102 221 V9.0.0, Mini-UICC govern the various SIM cards, and are incorporated herein by reference.

A SIM card stores network-specific information used to authenticate and identify subscribers on the network. The SIM also stores other carrier-specific data, such as the Short Message Service Center (SMSC) number, Service Provider Name (SPN), Service Dialing Numbers (SDN), Advice-Of-Charge parameters and Value Added Service (VAS) applications. SIM cards can often also store a plurality of address book contacts and/or SMS messages.

In the United States, cellular telephones are largely subsidized by wireless service providers. As a consequence, the cellular telephones are typically locked to a single SIM card, or exclude SIM cards altogether. However, many other countries (e.g., Italy, India and Belgium) do not follow this practice, and allow users to freely switch between networks and/or service providers. When a phone is not locked to a single SIM card, a user can easily switch between networks simply by replacing a current SIM card of one network with a SIM card of another network.

Similarly, a user may also wish to move their SIM card among various devices depending on their connection needs. For example, for telephone services, the user will need to have their SIM card in their cellular phone. However, to browse the internet or send emails, the user may prefer to connect to the wireless network from a laptop computer or tablet (e.g., an IPad®).

Current designs of wireless communication devices, however, typically secure the SIM card underneath a battery located within a battery compartment of the device. Consequently, to replace or move the SIM card, the user must first power down the device, remove the battery cover, remove the battery and extract the SIM card. After inserting a replacement SIM card into the device, the battery must be replaced, the battery cover must be reattached, and the device must be rebooted. This process is extremely cumbersome and wastes substantial amounts of time.

Consequently, there is a need for a wireless communication device that allows for easy access to the SIM card, and which allows for the SIM card to be removed within being shut down. Further aspects and advantages of the invention will become apparent from the detailed description that follows.

### BRIEF DESCRIPTION OF THE DRAWINGS/FIGURES

Embodiments of the invention are described with reference to the accompanying drawings. In the drawings, like reference numbers indicate identical or functionally similar elements. Additionally, the left most digit(s) of a reference number identifies the drawing in which the reference number first appears.

FIG. 1 illustrates a plan view of a conventional SIM card;

FIG. 2 illustrates a SIM-to-SD adaptor card according to an exemplary embodiment of the invention;

FIG. 3 illustrates a functional block diagram layout of a SIM-to-SD adaptor card according to an exemplary embodiment of the invention;

FIG. 4 illustrates a connection layout in a SIM-to-SD adaptor card according to an exemplary embodiment of the invention;

FIG. 5 illustrates plan view of a wireless communication device having an insertion slot for insertion of a SIM-to-SD adaptor card according to an exemplary embodiment of the invention; and

FIG. 6 illustrates a block diagram of a wireless communication device capable of communicating with a SIM-to-SD card adaptor according to an exemplary embodiment of the invention.

The invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

The following Detailed Description refers to accompanying drawings to illustrate exemplary embodiments consistent with the invention. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the invention. Therefore, the Detailed Description is not meant to limit the invention. Rather, the scope of the invention is defined only in accordance with the following claims and their equivalents.

Embodiments of the invention may be implemented in hardware (e.g., circuits), firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the invention. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the description of the present invention is to be described in terms of wireless communication (specifically cellular communication), those skilled in the relevant art(s) will recognize that the present invention may be applicable to other communications that use wired or other wireless communication methods without departing from the spirit and scope of the present invention.

An Exemplary SIM Card

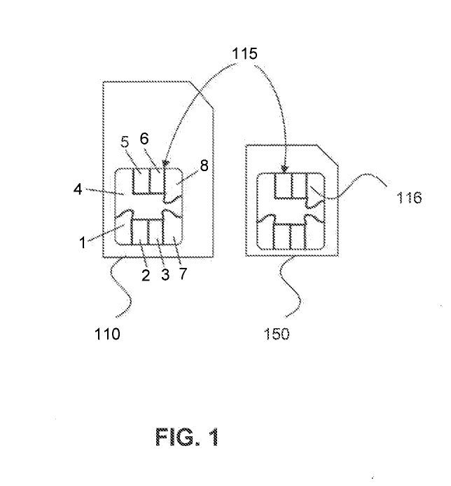

FIG. 1 illustrates a conventional “Mini” SIM card 110 and a conventional “Micro” SIM card 150. Each SIM card includes an IC chip embedded within. The IC chip stores various authentication data relating to the SIM card, as well as additional data stored by a user. Each SIM card includes a metal contact pattern 115 having a plurality of metal contacts 116. The metal contacts 116 are connected to terminals of the IC chip at an interior of the SIM card, and allow a wireless communication device to communicate with the IC chip when the SIM card is inserted in the device.

As shown in the magnified view of the metal contact pattern 115, the metal contact pattern 115 includes eight metal contacts 116. In other words, the SIM card has an 8-pin configuration. Each of the metal contacts 116 is designated for a specific use. For example, the metal contact pattern 115 has the following configuration: Pin 1—Power Supply (VCC); Pin 2—Reset (RST); Pin 3—Clock (CLK); Pin 4—Ground (GND); Pin 5—Programming Voltage Input (VPP); Pin 6—Input/Output (I/O); Pin 4—Auxiliary 1 (AUX1); and Pin 8—Auxiliary 2 (AUX2).

SIM cards are manufactured to a variety of size specification.

According to their respective standards, a Mini SIM card is 25.00 L×15.00 W×0.76 D (mm) and a Micro SIM card is 15.00 L×12.00 W×0.76 D (mm). The metal contact pattern 155 remains a constant size among the various sized SIM cards.

A SIM-To-SD Adaptor Card According to an Exemplary Embodiment

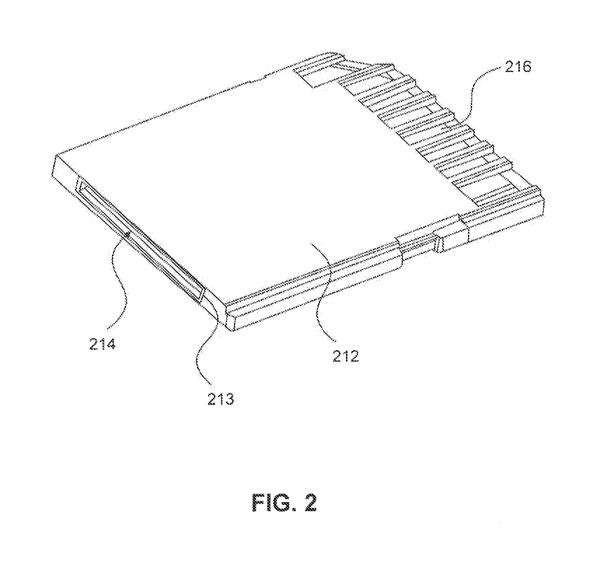

FIG. 2 illustrates a SIM-to-SD adaptor card 200 according to an exemplary embodiment of the invention. The SIM-to-SD adaptor card 200 includes a SIM receptor slot 214 capable of receiving a SIM card 201.

The SIM-to-SD adaptor card 200 is shaped according to the standard dimensions of any standard Secure Digital (SD) card, as defined by the SD Card Association. An SD card is a non-volatile memory card format developed by the SD Card Association for use in portable devices. SD cards can include a wide range of memory capacities (e.g., from 1 MB to 2 TB) and come in a variety of standardized sizes. For example, a “Standard” SD card is 32 L×24 W×2.1 D (mm), a Mini SD card is 21.5 L×20 W×1.4 D (mm) and a Micro SD card is 15 L×11 W×1.0 D (mm), each with its own unique shape.

In order to be receivable by standard SD Input/Output (SDIO) terminals, the size and shape of the SIM-to-SD adaptor card 200 should be equivalent to one of the standardized SD card dimensions, discussed above. Depending on the application, the SIM-to-SD adaptor card 200 can replicate any one of the Standard, Mini or Micro SD card dimensions. For purposes of this discussion, however, the SIM-to-SD adaptor card 200 conforms to the size specifications of a Standard-sized SD card.

The SIM-to-SD adaptor card 200 includes a housing 212 that houses the internal circuitry of the adaptor card 200. The housing 212 includes an opening 213 that provides access to the SIM receptor slot 214. The opening can be any indentation, recess, or slot that allows a SIM card to contact the internal circuitry of the SIM-to-SD adaptor card 200. The SIM receptor slot 214, together with the opening 213, is capable of receiving a SIM card 201. The SIM receptor slot 214 can be configured to receive at least one of a Standard-sized SIM card, a Mini-sized SIM card or a Micro-sized SIM card. For purposes of this discussion, the SIM receptor slot 214 has dimensions sufficient to receive a mini SIM card.

The SIM-to-SD adaptor card 200 also includes a plurality of terminals 216. The terminals 216 allow the internal circuitry of the SIM-to-SD card 210 to communicate with a device in communicative contact with the terminals 216.

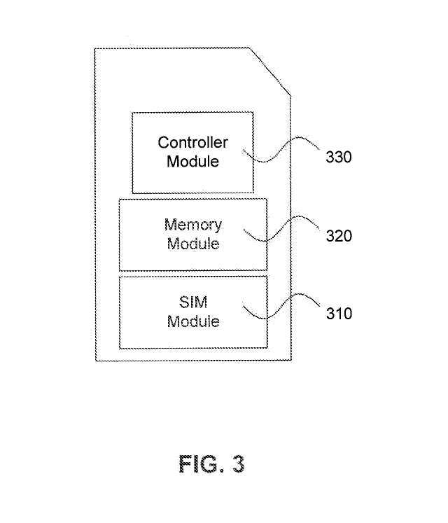

FIG. 3 illustrates a functional block diagram layout of a SIM-to-SD adaptor card 300 according to an exemplary embodiment of the invention. The SIM-to-SD adaptor card 300 includes a SIM module 310 and a controller module 330, and may represent an exemplary functional embodiment of the SIM-to-SD adaptor card 200.

The SIM module 310 includes the necessary structure for contacting with the metal contact pattern 115 of a SIM card, and should be located at or near the SIM receptor slot 214. For example, the SIM module 310 may include a plurality of pins or contact pads for contacting each of the metal contacts 116 of the contact pattern 115. The SIM module 310 transfers electrical signals between an inserted SIM card and the controller module 330, discussed below.

The SIM-to-SD adaptor card 300 may also include a memory module 320. The memory module 320 is a non-volatile memory chip capable of storing electrical data. Including the memory module 320 in the SIM-to-SD adaptor card 300 allows for the adaptor card to retain a significant amount of SD card functionality by allowing it to expand a device's memory capacity. The memory module 320 should be formatted in accordance with the SD Card Association specification, which is incorporated herein by reference. The memory module 320 is also connected to the controller module 330.

The controller module 330 receives instruction signals and/or data signals from a host device in which the SIM-to-SD adaptor card 300 resides. An instruction signal can be an instruction to retrieve information from, or record information to, either the memory module 320 or a SIM card via the SIM module 310. Upon receipt of an instruction from the host device, the controller module 330 processes the instruction and performs the requested action. The controller module 330 then processes and forwards response signals, if necessary, to the host device via the terminals 216 of the SIM-to-SD adaptor card 300. The processing performed by the controller module 330 will be discussed in further detail below.

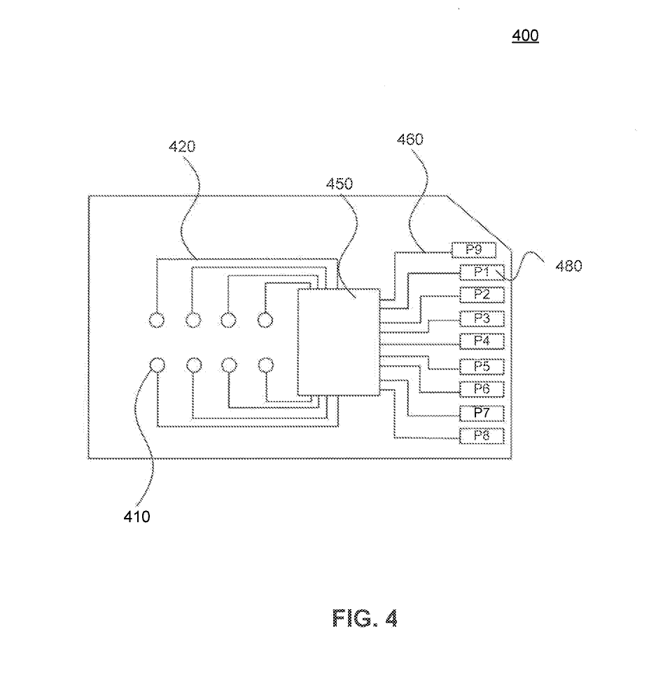

FIG. 4 illustrates a connection layout in a SIM-to-SD card adaptor 400 according to an exemplary embodiment of the invention. The SIM-to-SD adaptor card 400 includes a plurality of SIM pins 410 and a signal conversion module 450 and may represent an exemplary embodiment of the SIM-to-SD adaptor card 300. For simplicity of discussion, FIG. 4 illustrates only the components of the SIM-to-SD adaptor card 400 relating to communication with a SIM card.

The SIM-to-SD adaptor card 400 includes the plurality of SIM pins 410. The SIM pins 410 are arranged corresponding to a resting location of the metal contact pattern 115 of an inserted SIM card. Each SIM pin 410 corresponds to a single metal contact 116 of the metal contact pattern 115. A plurality of SIM connecting wires 420 connect the plurality of SIM pins 410 to the signal conversion module 450 and transmit electrical signals between an inserted SIM card and the signal conversion module 450.

The SIM-to-SD adaptor card 400 also includes a plurality of SD terminals 480 disposed along an edge. A plurality of I/O wires 460 connect the SD terminals 480 to the signal conversion module 450. When the SIM-to-SD adaptor card 400 is inserted within an SDIO port of a host device, the SD terminals 480 provide electrical contacts to the SDIO port and receive electrical signals, such as instruction signals or data signals, from the host device. The SD terminals 480 provide the received instruction/data signals to the signal conversion module 450 via the I/O wires 460.

The signal conversion module 450 receives and processes the received instruction/data signals. Because the SIM-to-SD adaptor card 400 is located within an SDIO terminal, the signals transmitted by the device will utilize the SD communication protocol. Consequently, signals directed to the memory module of the SIM-to-SD adaptor card 400 do not require any additional processing. In other words, if the received signal relates to the memory module, the signal conversion module 450 simply processes the instruction to either retrieve data from, or store data in, the memory module. The signal conversion module 450 then executes the instruction.

Alternatively, if the received signal relates to the SIM module, the signal conversion module 450 must convert the signal into SIM format. Specifically, as discussed above, SIM cards include an 8-pin metal contact pattern 115, with each metal contact 116 being specifically designated for a particular signal. The SD cards, on the other hand, include anywhere from 8 pins to 11 pins, each with its own different signal designation. For example, with respect to the SD terminals 480 shown in FIG. 4, the pin configuration is as follows: Pin 1—Data 3; Pin 2—Command; Pin 3—Ground; Pin 4—Power Supply; Pin 5—Clock; Pin 6—Ground; Pin 7—Data 0; Pin 8—Data 1; and Pin 9—Data 2.

Thus, upon receiving an instruction designated for the SIM module, the signal conversion module 450 converts the received SD protocol signal into a SIM protocol signal based on the pin configuration of the SIM card. This may involve rearranging signals (including converting voltage levels) and/or converting instruction compliant with SD protocol into instructions compliant with SIM protocol, etc. The signal conversion module 450 then forwards the converted signal to the SIM card via the SIM connecting wires 420 and the SIM pins 410.

When the instruction signal requires a response from the SIM card, such as when the instruction signal requests information stored on the SIM card, the SIM card will respond to the received instruction signal accordingly. The SIM card supplies the response signal to the signal conversion module 450 using the SIM protocol via the SIM pins 410 and the SIM connecting wires 420.

The signal conversion module 450 receives the response signal from the SIM card and converts the signal into SD format. The process of converting the SIM response signal into an SD response signal is substantially the inverse of the conversion of the received signal from SD format into SIM format. After conversion, the signal conversion module 450 outputs the converted response signal to the SD terminals 480 via the I/O wires 460. The SD terminals then transmit the response signal to the host device via its SDIO interface.

Those skilled in the relevant art(s) will recognize that many configurations are available for the SIM-to-SD card adaptor beyond those discussed above. For example, the SIM receptor slot can be located on any side of the adaptor, and can constitute a port, recess or surface of the adaptor. Further, the adaptor may arrange the SIM module, memory module and controller module as desired, and may exclude the memory module altogether.

A Wireless Communication Device According to an Exemplary Embodiment

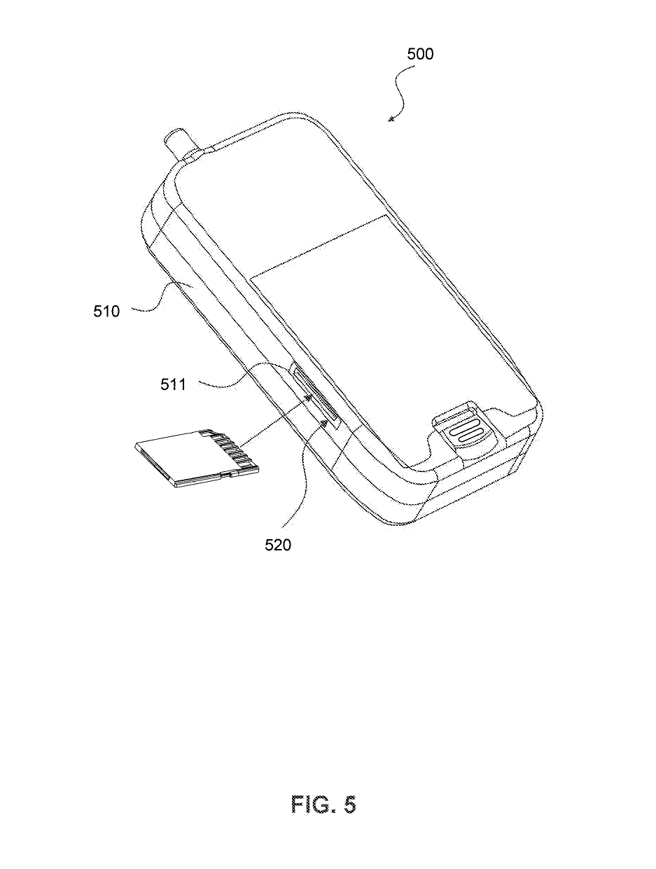

FIG. 5 illustrates a wireless communication device 500 according to an exemplary embodiment of the invention. The wireless communication device 500 includes an SDIO terminal 520 for receiving an SD-type device, where the SDIO terminal 520 includes a SIM-to-SD card adaptor as shown in FIGS. 2-4.

The wireless communication device 500 includes a housing 510 that houses the internal circuitry of the wireless communication device 500. The housing 510 includes an opening 511, allowing access to the SDIO terminal 520 contained within the wireless communication device 500. The SDIO terminal 520 is configured to receive an SD-type memory adaptor card, including at least one of a Standard, Mini or Micro SD-type card.

The SDIO terminal 520 includes a plurality of metal contacts disposed within the SDIO terminal 520 that are arranged corresponding to a plurality of SD terminals (e.g. SD terminals 216) located on an SD-type memory/adaptor card. When an SD-type memory/adaptor card is disposed within the SDIO terminal 520, the metal contacts of the SDIO terminal electrically contact the SD terminals, thereby allowing communication between the wireless communication device and the SD-type card.

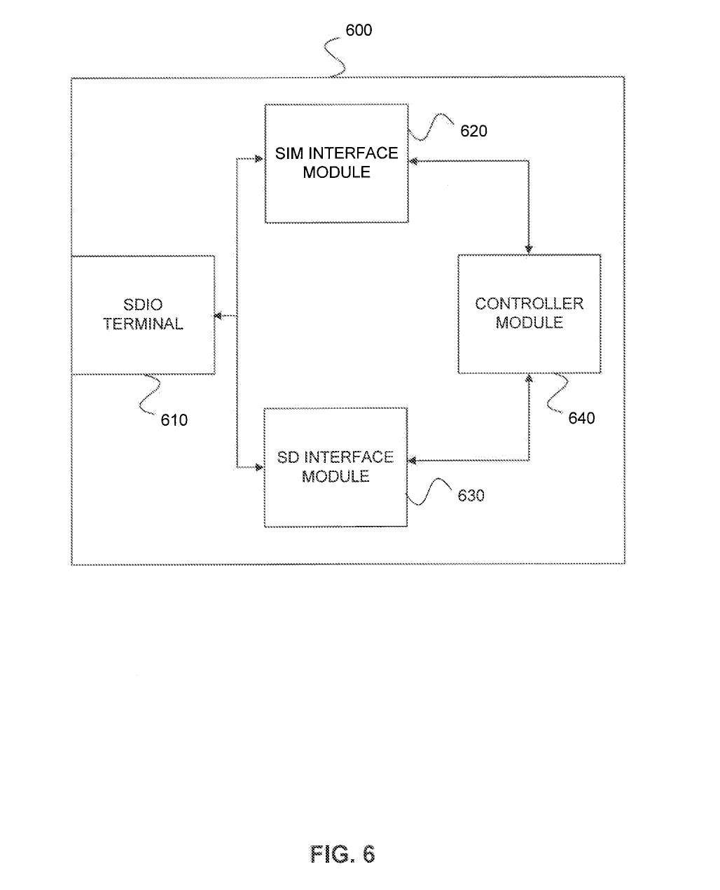

FIG. 6 illustrates a block diagram of a wireless communication device 600 capable of communicating with a SIM-to-SD adaptor card according to an exemplary embodiment of the invention. The wireless communication device 600 includes an SDIO terminal 610 and a SIM interface module 620, and may represent an exemplary embodiment of the wireless communication device 500.

The SDIO terminal 610 may represent an exemplary embodiment of the SDIO terminal 520, and is capable of receiving and communicating with an SD-type memory/adaptor card. The wireless communication device 600 includes an SD interface module 630 that provides standard SD interfacing between the SDIO terminal 610 and a controller module 640.

The controller module 640 periodically instructs the SD interface module 630 to interrogate the SDIO terminal 610 in order to determine if the SDIO terminal 610 contains an SD-type card. Once an SD-type card is inserted into the SDIO terminal 610, the SDIO terminal 610 responds to the interrogation that the card is present, and sends several pieces of initializing information relating to the inserted card, such as a card ID. The SDIO also returns additional information, including whether the SD-type card includes any SIM capabilities, and whether the card includes any SD memory.

When the wireless communication device 600 needs to access the SD memory contained on the SIM-to-SD adaptor card, the controller 640 instructs the SD interface module 630 accordingly. The SD interface module 630 prepares instructions signals based on the received instruction from the controller 640. For example, if the controller 640 wishes to obtain information stored in the SD memory, the SD interface module 630 simply prepares a request in accordance with SD protocol and forwards the request to the SDIO terminal 610. The SDIO terminal 610 then transmits the request to the SIM-to-SD adaptor card. The SIM-to-SD adaptor transmits a response signal that includes the requested data in response to the request.

Upon receipt of the response, the SDIO terminal 610 identifies the response signal being from the SD memory, and forwards the response signal to the SD interface module 630. After receiving the response signal, the SD interface module extracts the requested information and forwards the information to the controller module 640 for further processing.

Alternatively, when the wireless communication device 600 wishes to access the SIM card, the controller module 640 instructs the SIM interface module 620 accordingly. The SIM interface module 620, upon receiving the instruction from the controller module 640, prepares a SIM request signal. The SIM request signal may include a header that identifies the request as being designated for the SIM card. The SIM interface module 620 forwards the SIM request signal to the SDIO terminal 610 using SD protocol. The SDIO terminal 610 transmits the SIM request signal to the SIM-to-SD adaptor card.

After receiving the SIM request signal, the SIM-to-SD adaptor card identifies the request signal as being designated for the SIM card based on the signal header. The SIM-to-SD adaptor card then converts the request signal from SD to SIM protocol and issues the converted request to the SIM card, as discussed herein with respect to FIGS. 2-4. The adaptor then issues a response signal to the SDIO terminal 610 accordingly, that contains the requested information.

The SDIO terminal 610 receives the response signal from the SIM-to-SD adaptor card, and forwards the response signal to the SIM interface module 620. The SIM interface module extracts any requested information, and forwards the response/information to the controller module 640 for further processing.

Those skilled in the relevant art(s) will recognize that many other configurations of the wireless communication device 600 may be implemented depending on the particular application. For example, most current wireless devices include a slot designated for SD and another separate slot designated for SIM. Consequently, most devices already include both a SIM interface module and an SD interface module. Therefore, the above description provides a simple modification to existing devices in order to enable communication with both SIM and SD on a single SDIO terminal. However, the SIM interface module and the SD interface module may be integrated into a single communication module that configures and transmits request signals to the SDIO terminal, or may be incorporated within the controller module.

### CONCLUSION

It is to be appreciated that the Detailed Description section, and not the Abstract section, is intended to be used to interpret the claims. The Abstract section may set forth one or more, but not all exemplary embodiments, of the invention, and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the invention. Thus the invention should not be limited by any of the above-described exemplary embodiments, but should be defined only in accordance with the following claims and their equivalents.

What is claimed is:

1. An adaptor apparatus capable of being received by an SDIO terminal of an electronics device, the adaptor apparatus comprising:
a SIM card receiving terminal configured to communicatively receive a SIM card,
wherein, when the SIM card is inserted into the SIM card receiving terminal and the adaptor apparatus has been received by the SDIO terminal of the electronics device, the electronics device is capable of communicating with the SIM card.

2. The adaptor apparatus of claim 1, further comprising a memory configured to store information.

3. The adaptor apparatus of claim 1, wherein the SIM card includes a plurality of electrical pads, and
an inner surface of the SIM card receiving terminal includes a SIM interface configured to interface with the plurality of electrical pads.

4. The adaptor apparatus of claim 3, further comprising:
a plurality of SD terminals; and
a signal conversion module configured to transmit data from the SIM card to the plurality of SD terminals.

5. The adaptor apparatus of claim 4, wherein the adaptor apparatus and the electronics device exchange information using an SD protocol,
wherein, for signals being transmitted from the SD terminals to the SIM card, the signal conversion module converts the signals from the SD protocol to a SIM protocol, and
wherein, for signals being transmitted from the SIM card to the SD terminals, the signal conversion module converts the signals from the SIM protocol to the SD protocol.

6. The adaptor apparatus of claim 1, further comprising a memory module configured to store electrical data.

7. The adaptor apparatus of claim 6, wherein the signal conversion module determines whether a signal received from the electronic device is designated for the SIM card or the memory module based on a flag set within the received signal, and
wherein the signal conversion module transmits the received signal to either the SIM card or the memory module based on the determination.

8. The adaptor apparatus of claim 7, wherein the adaptor apparatus and the electronics device exchange information using an SD protocol,
wherein, when it is determined that the received signal is designated for the SIM card, the signal conversion module converts the received signal from the SD protocol to a SIM protocol before transmitting the received signal, and
wherein, when it is determined that the received signal is designated for the memory module, the signal conversion module transmits the received signal without conversion.

9. The adaptor apparatus of claim 1, wherein the adaptor apparatus has a shape and dimensions of any of a Standard SD card, a Mini SD card, or a Micro SD card.

10. A system, comprising:
an electronics device, including:
an SDIO terminal; and
an adaptor configured to be communicatively received by the SDIO terminal of the electronics device, the adaptor including:
a SIM card receiving terminal configured to communicatively receive a SIM card,
wherein, when the SIM card is inserted into the SIM card receiving terminal and the adaptor has been received by the SDIO terminal of the electronics device, the electronics device is capable of communicating with the SIM card.

11. The system of claim 10, the adaptor further including a memory configured to store electrical data.

12. The system of claim 10, wherein the SIM card includes a plurality of electrical pads, and
an inner surface of the SIM card receiving terminal includes a SIM interface configured to interface with the plurality of electrical pads.

13. The system of claim 10, the adaptor further including:
a plurality of SD terminals; and
a signal conversion module configured to transmit data from the SIM card to the plurality of SD terminals.

14. The system of claim 6, the electronics device further including a SIM communication module configured to generate a SIM signal designated for the SIM card.

15. The system of claim 14, wherein the SIM signal generated by the SIM communication module of the electronics device is compliant with an SD protocol.

16. The system of claim 14, wherein the SIM signal generated by the SIM communication module of the electronics device includes a flag set to designate the SIM signal for the SIM card.
